(19) United States
(12) Patent Application Publication
(10) Pub. No.: US 2024/0201218 A1
(43) Pub. Date: Jun. 20, 2024

(54) AUTOMATIC ANALYZER AND CONTROL METHOD THEREFOR

(71) Applicant: Hitachi High-Tech Corporation, Tokyo (JP)

(72) Inventors: Mayuko ITO, Tokyo (JP); Shinya MATSUOKA, Tokyo (JP)

(73) Assignee: Hitachi High-Tech Corporation, Tokyo (JP)

(21) Appl. No.: 18/555,737

(22) PCT Filed: Jan. 27, 2022
(86) PCT No.: PCT/JP2022/003097

§ 371 Date: Oct. 17, 2023

(30) Foreign Application Priority Data
Apr. 20, 2021 (JP) 2021-070924

(51) Int. Cl. G01N 35/10

(52) U.S. Cl. CPC G01N 35/1004; G01N 35/1002

(57) ABSTRACT

Provided is an automatic analyzer capable of preventing precipitation of a solute in a cleaning liquid in a reservoir used for cleaning a dispensing probe. The automatic analyzer for analyzing a sample includes a dispensing probe configured to dispense the sample or a reagent, a reservoir configured to reserve a cleaning liquid used for cleaning the dispensing probe, a flow path connected to the reservoir and through which the cleaning liquid flows, and a control unit configured to control each unit. The control unit draws the cleaning liquid in the reservoir into the flow path, and then supplies system water to the reservoir.

### TECHNICAL FIELD

This invention relates to an automatic analyzer.

### BACKGROUND ART

An automatic analyzer automatically qualitatively, or quantitatively, analyzes a specific component contained in a sample, such as blood or urine. In the automatic analyzer, a dispensing probe to dispense the sample is appropriately cleaned to suppress generation of contamination and maintain analytical accuracy. A cleaning liquid reserved in a reservoir is used to clean the dispensing probe. When a highly volatile cleaning liquid is used, a solute may precipitate if left exposed to the atmosphere for a long time. In addition, a component harmful to a human body or environment, such as an organic solvent, disadvantageously evaporates. The precipitation can be prevented by water displacement of the flow path. However, if all the cleaning liquid in the flow path is replaced, the cleaning liquid is unnecessarily consumed.

In patent literature 1, therefore, internal washing water is discharged from the dispensing probe into the reservoir, and the cleaning liquid is replaced with water by pushing the cleaning liquid out of the reservoir, thereby precipitation of the solute is prevented without consuming the cleaning liquid unnecessarily.

### CITATION LIST

### Patent Literature

PTL 1: Japanese Unexamined Patent Application Publication No. 2019-74311.

### SUMMARY OF INVENTION

### Technical Problem

However, PTL 1 gives insufficient consideration to precipitation of the solute in the cleaning liquid and to volatilization of a component of the cleaning liquid. Specifically, although contaminated cleaning liquid is discharged by discharging the internal washing water from the dispensing probe to the cleaning liquid reserved in the reservoir, some cleaning liquid diluted with water remains in the reservoir, and thus the solute may precipitate from the cleaning liquid and clog the dispensing probe.

Therefore, an object of the present invention is to provide an automatic analyzer that can suppress precipitation of the solute in the cleaning liquid in the reservoir used for cleaning the dispensing probe.

### Solution to Problem

To achieve the object, the invention is characterized in that the cleaning liquid reserved in the reservoir is drawn into a flow path connected to the reservoir, and then system water is supplied to the reservoir.

More specifically, this invention provides an automatic analyzer for analyzing a sample. The automatic analyzer comprises: a dispensing probe configured to dispense the sample or a reagent; a reservoir configured to reserve a cleaning liquid used for cleaning the dispensing probe; a flow path connected to the reservoir and through which the cleaning liquid flows; and a control unit configured to control each unit. In the automatic analyzer, the control unit draws the cleaning liquid in the reservoir into the flow path, and then supplies system water to the reservoir.

Further, this invention provides a method for controlling an automatic analyzer for analyzing a sample. The method comprises: drawing a cleaning liquid reserved in a reservoir, the cleaning liquid being used for cleaning a dispensing probe for dispensing the sample or a reagent, into a flow path connected to the reservoir and through which the cleaning liquid flows; and supplying system water to the reservoir.

### Advantageous Effects of Invention

According to the invention, an automatic analyzer can be provided, which is capable of preventing precipitation of a solute in a cleaning liquid in a reservoir used for cleaning a dispensing probe.

### BRIEF DESCRIPTION OF DRAWINGS

FIG. 1 is a plan view showing a configuration example of an automatic analyzer.

FIG. 2 shows a cleaning tank including a reservoir.

FIG. 3 shows an operation according to a first embodiment.

FIG. 4 shows an operation according to a second embodiment.

### DESCRIPTION OF EMBODIMENTS

Hereinafter, some preferred embodiments of the automatic analyzer according to the invention will be described with reference to the accompanying drawings. The automatic analyzer analyzes a sample using a reaction liquid obtained by reacting a sample, such as blood or urine, with a reagent.

### First Embodiment

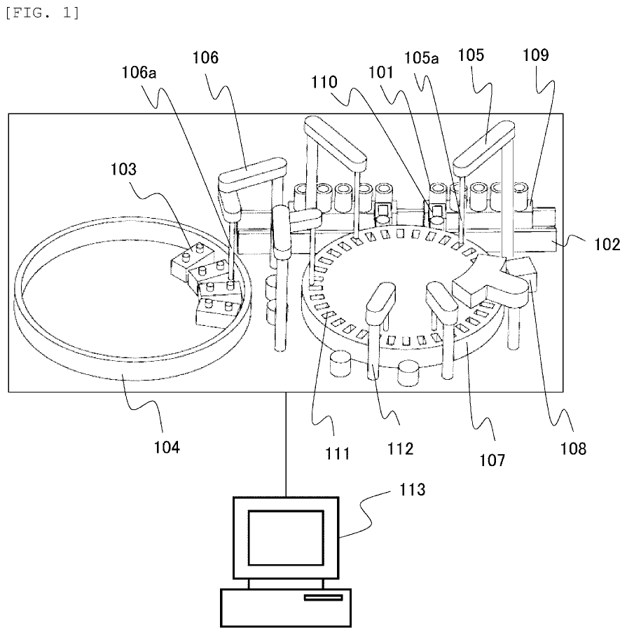

An example of an overall configuration of the automatic analyzer of a first embodiment is described with reference to FIG. 1. The automatic analyzer includes a sample transport unit 102, a reagent disk 104, a sample dispensing unit 105, a reagent dispensing unit 106, a reaction disk 107, a measurement unit 108, a cleaning tank 110, and a control unit 113. Each unit is now described. The vertical direction is defined as a Z direction, and the horizontal plane is defined as an XY plane.

The sample transport unit 102 transports a sample container 101, which is placed on a sample rack 109 while housing a sample such as blood or urine, to a position at which the sample dispensing unit 105 can access the sample container 101.

The sample dispensing unit 105 dispenses the sample from the sample container 101 transported by the sample transport unit 102 into a reaction container 111 disposed on the reaction disk 107. A sample dispensing probe 105a of the sample dispensing unit 105 is used for dispensing the sample. Specifically, the sample dispensing probe 105a is put into the sample container 101 and aspirates the sample, and then moves to the reaction container 111 to discharge the sample.

The reaction disk 107 keeps a plurality of reaction containers 111, arranged in a circumferential manner, within a predetermined temperature range, and also transports a reaction container 111, into which the sample has been dispensed, to a position at which the reagent dispensing unit 106 can access the reaction container 111.

The reagent disk 104 stores a reagent container 103, which houses a reagent to be used for analysis, at a temperature within a predetermined temperature range.

The reagent dispensing unit 106 dispenses the reagent from the reagent container 103 stored by the reagent disk 104 into the reaction container 111 into which the sample has been dispensed. A reagent dispensing probe 106a of the reagent dispensing unit 106 is used to dispense the reagent. Specifically, the reagent dispensing probe 106a is put into the reagent container 103 and aspirates the reagent, and then moves to the reaction container 111 and discharges the reagent.

The reaction container 111, into which the sample and the reagent have been dispensed, is transported by the reaction disk 107 to a position at which the stirring unit 112 can access the reaction container 111. The stirring unit 112 stirs the sample and the reagent in the reaction container 111. The heat retention by the reaction disk 107 and the stirring by the stirring unit 112 accelerate a reaction between the sample and the reagent in the reaction container 111 to produce a reaction liquid. The reaction disk 107 transports the reaction container 111 housing the reaction liquid to the measurement unit 108.

The measurement unit 108 measures physical properties of the reaction liquid housed in the reaction container 111, such as the amount of light emitted, the amount of scattered light, the amount of transmitted light, a current value, and a voltage value, for example. It is to be noted that the physical properties to be measured are not limited to these. The physical properties measured by the measurement unit 108 are transmitted to the control unit 113.

The control unit 113 is a device, which receives the physical properties transmitted from the measurement unit 108 and outputs analysis results and also controls the respective units of the automatic analyzer, and is, for example, configured by a so-called computer.

The sample dispensing probe 105a of the sample dispensing unit 105 and the reagent dispensing probe 106a of the reagent dispensing unit 106 are cleaned using a cleaning liquid after dispensing the sample and the reagent in order to suppress generation of contamination. Usable cleaning liquids include highly volatile solutions such as organic solvents, alkaline solutions, and neutral solutions containing surfactants.

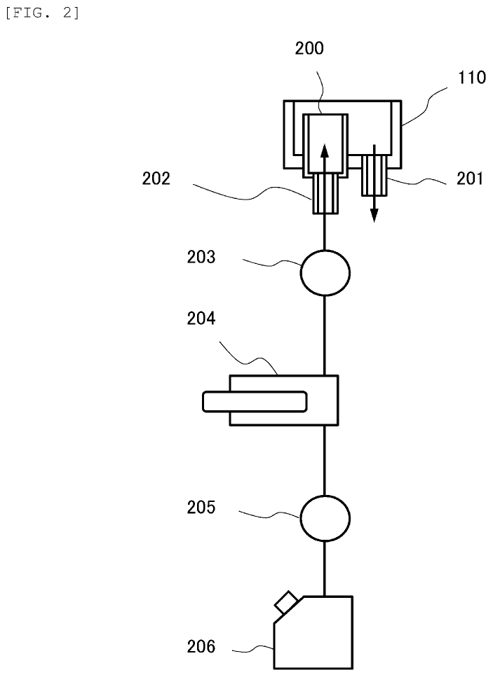

The cleaning tank 110 used for cleaning the sample dispensing probe 105a of the sample dispensing unit 105 is now descried with reference to FIG. 2. The reagent dispensing probe 106a of the reagent dispensing unit 106 is also cleaned by the same mechanism as that for the cleaning tank 110. The cleaning tank 110 has a reservoir 200 for reserving the cleaning liquid used for cleaning the sample dispensing probe 105a, and a discharge tube 201 for discharging the cleaning liquid used for cleaning, and the like.

A flow path 202 is connected to the reservoir 200, and the cleaning liquid stored in a tank 206 is supplied to the reservoir 200 through the flow path 202. The inner diameter of the flow path 202 is sufficiently smaller than the inner diameter of the reservoir 200, for example, the inner diameter of the flow path 202 is less than 2 mm while the inner diameter of the reservoir 200 is 5 to 6 mm. A first valve 203, a syringe 204, and a second valve 205 are provided between the flow path 202 and the tank 206. The first valve 203 controls opening and closing between the flow path 202 and the syringe 204. The syringe 204 aspirates or discharges the cleaning liquid. The first valve 203 controls opening and closing between the syringe 204 and the tank 206.

Description is given on operations of the first valve 203, the syringe 204, and the second valve 205 when the cleaning liquid stored in the tank 206 is supplied to the reservoir 200. First, while the first valve 203 is closed and the second valve 205 is open, the syringe 204 aspirates the cleaning liquid in the tank 206. Subsequently, while the second valve 205 is closed and the first valve 203 is open, the syringe 204 discharges the cleaning liquid, thereby the cleaning liquid is supplied to the reservoir 200 through the flow path 202. Repeating the operations of the first valve 203, the syringe 204, and the second valve 205 makes it possible to supply the cleaning liquid in an amount exceeding the capacity of the reservoir 200 and cause the cleaning liquid to overflow from the reservoir 200. The cleaning liquid overflowing from the reservoir 200 is discharged through the discharge tube 201.

If the cleaning liquid supplied to the reservoir 200 is left for a long time, a solute may precipitate due to the volatilization of a solvent, and the precipitated solute may clog the sample dispensing probe 105a. In the first embodiment, therefore, precipitation of the solute is suppressed by the following operation.

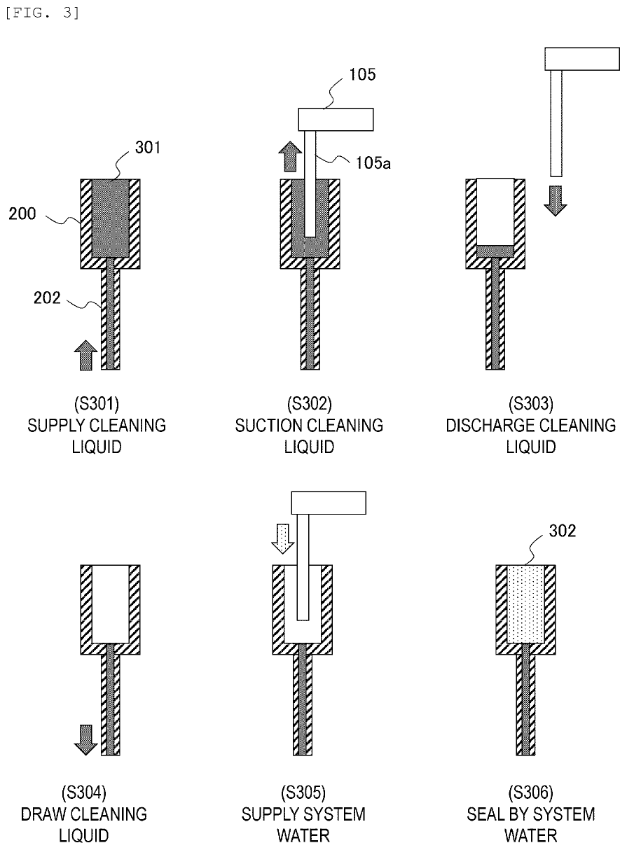

The operation in the first embodiment is now described step by step with reference to FIG. 3.

### (S301)

The control unit 113 controls the first valve 203, the syringe 204, and the second valve 205 to supply the cleaning liquid 301 to the reservoir 200. When a predetermined amount of cleaning liquid 301 is supplied to the reservoir 200, the first valve 203 is closed.

### (S302)

The control unit 113 controls the sample dispensing unit 105 so that the cleaning liquid 301 is aspirated by the sample dispensing probe 105a.

### (S303)

The control unit 113 controls the sample dispensing unit 105 to discharge the cleaning liquid 301 to the outside of the reservoir 200. S302 and S303 may be repeated to clean the sample dispensing probe 105a. Since the sample dispensing probe 105a cannot fully aspirate the cleaning liquid 301 in the reservoir 200, some cleaning liquid 301 remains at the bottom of the reservoir 200.

In this stage, the cleaning liquid 301 may be supplied once to the reservoir 200 so as to overflow. This makes it possible to remove the cleaning liquid 301, which may have been in contact with the sample dispensing probe 105a and thus contaminated, from the reservoir 200. If such contamination of the cleaning liquid 301 by the sample dispensing probe 105a is substantially not a problem, this step may be omitted. After the cleaning liquid 301 is supplied to the reservoir 200, there may be provided the process again, in which the control unit 113 controls the sample dispensing unit 105 to discharge the cleaning liquid 301 to the outside of the reservoir 200.

### (S304)

The control unit 113 controls the first valve 203 and the syringe 204 to draw the cleaning liquid 301, which remains at the bottom of the reservoir 200, into the flow path 202. Specifically, the syringe 204 aspirates the cleaning liquid 301 while the first valve 203 is open, thereby the cleaning liquid 301 is drawn into the flow path 202 such that the liquid level of the cleaning liquid 301 is located at/below the upper end of the flow path 202. When the cleaning liquid 301 is drawn into the flow path 202, the first valve 203 is closed.

### (S305)

The control unit 113 controls the sample dispensing unit 105 to supply system water 302 from the sample dispensing probe 105a to the reservoir 200. Since the cleaning liquid 301 is drawn into the flow path 202 having a sufficiently smaller inner diameter than that of the reservoir 200, diffusion of the cleaning liquid 301 toward the system water 302 is suppressed.

### (S306)

A predetermined amount of system water 302 is supplied to the reservoir 200, and thus the cleaning liquid 301 is sealed by the system water 302. Since the cleaning liquid 301 sealed by the system water 302 is not exposed to the atmosphere, the solvent does not volatilize even if left for a long time.

According to the operation described above, since the cleaning liquid 301 in the reservoir 200 escapes volatilization of the solvent, precipitation of the solute is suppressed. In addition, precipitation of the solute in the cleaning liquid 301 is suppressed, and thus the sample dispensing probe 105a can be prevented from clogging. When the system water 302, which is supplied to the reservoir 200 to seal the cleaning liquid 301, is replaced with the cleaning liquid 301, at least part of the system water 302 is preferably beforehand discharged to the outside of the reservoir 200 by the sample dispensing probe 105a. At least part of the system water 302 is thus beforehand discharged to the outside of the reservoir 200 by the sample dispensing probe 105a, making it possible to reduce the amount of the cleaning liquid 301 supplied from the flow path 202.

If all the system water 302 in the reservoir 200 is caused to overflow by the cleaning liquid 301 supplied from the flow path 202, a large amount of the cleaning liquid 301 is required because replacement proceeds while the system water 302 and the cleaning liquid 301 are increasingly mixed together. In contrast, when at least part of the system water 302 is beforehand discharged to the outside of the reservoir 200, since less system water 302 mixes with the cleaning liquid 301 supplied from the flow path 202, a decreased amount of the cleaning liquid 301 can be supplied.

### Second Embodiment

In the description of the first embodiment, the system water 302 is used to seal the cleaning liquid 301 drawn into the flow path 202 connected to the reservoir 200. Although diffusion of the cleaning liquid 301, which has been drawn into the flow path 202, toward the system water 302 is suppressed, such diffusion is not perfectly prevented. When the cleaning liquid 301 that has diffused toward the system water 302 comes into contact with the atmosphere, the solute may precipitate. In the description of the second embodiment, therefore, the cleaning liquid 301 is prevented from diffusing toward the system water 302. Since respective configurations of the automatic analyzer and the cleaning tank 110 in the second embodiment are the same as those in the first embodiment, duplicated description is omitted.

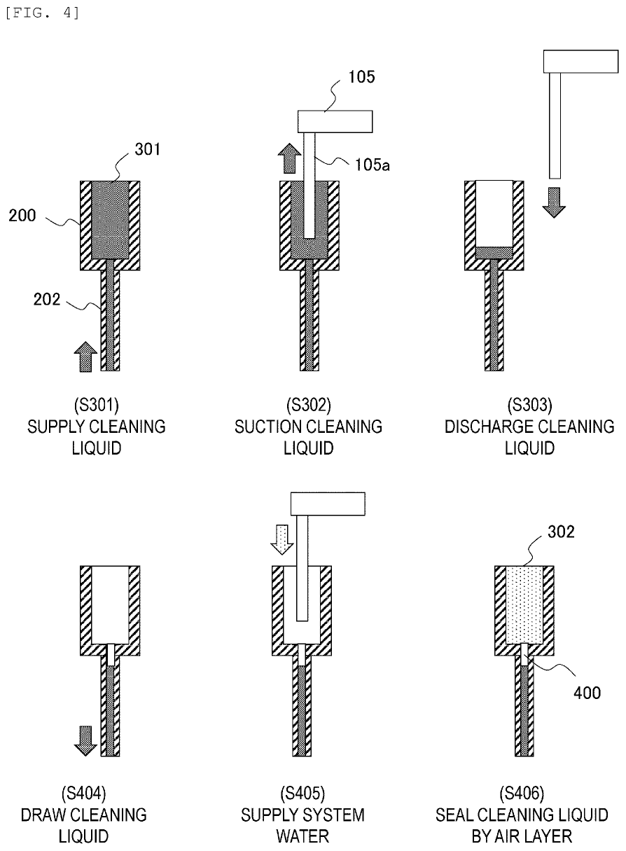

Operations in the second embodiment are now described step by step with reference to FIG. 4. The same step numbers are given to the same operations as in the first embodiment to simplify the description.

### (S301) to (S303)

As in the first embodiment, the cleaning liquid 301 supplied to the reservoir 200 is aspirated by the sample dispensing probe 105a and discharged to the outside of the reservoir 200. Some cleaning liquid 301 remains at the bottom of the reservoir 200.

### (S404)

The control unit 113 controls the first valve 203 and the syringe 204 to draw the cleaning liquid 301, which remains at the bottom of the reservoir 200, into the flow path 202. Specifically, the syringe 204 aspirates the cleaning liquid 301 while the first valve 203 is open, the cleaning liquid 301 is drawn into the flow path 202 such that the liquid level of the cleaning liquid 301 is located below, for example, about 2 to 3 mm below, the upper end of the flow path 202.

### (S405)

The control unit 113 controls the sample dispensing unit 105 to supply the system water 302 from the sample dispensing probe 105a to the reservoir 200. Due to pressure of air that exists between the upper end of the flow path 202 and the liquid level of the cleaning liquid 301, the system water 302 cannot flow into the flow path 202 and remains in the reservoir 200. As a result, an air layer 400 is formed between the system water 302 and the cleaning liquid 301.

### (S306)

A predetermined amount of system water 302 is supplied to the reservoir 200, and thus the cleaning liquid 301 is sealed by the system water 302 and isolated from the system water 302 by the air layer 400. Since the cleaning liquid 301, sealed by the system water 302 and the air layer 400, is not exposed to the atmosphere, the solvent does not volatilize even if the cleaning liquid 301 is left for a long time. Further, the cleaning liquid 301 isolated from the system water 302 by the air layer 400 will not diffuse toward the system water 302.

According to the operation described above, the cleaning liquid 301 in the reservoir 200 does not diffuse toward the system water 302, making it possible to prevent volatilization of the solvent and precipitation of the solute. In addition, since precipitation of the solute in the cleaning liquid 301 can be suppressed, clogging of the sample dispensing probe 105a is eliminated.

The operation illustrated in FIG. 3 or 4 may be performed when waiting time before cleaning using the cleaning liquid 301 in the reservoir 200 is longer than a predetermined threshold. At this time, the threshold is preferably set depending on a type of the cleaning liquid, for example, whether the cleaning liquid is of a highly volatile type. For example, the threshold is set to 10 min for a highly volatile cleaning liquid including an organic solvent or the like, and set to 1 hr for an alkaline cleaning liquid having a relatively low volatility.

Hereinbefore, several embodiments of the invention have been described. The invention is not limited to the described embodiments, and the elements of the invention may each be modified within the scope without departing from the gist of the invention. The plurality of elements disclosed in the embodiments may be combined as appropriate. Furthermore, some elements may be deleted from all the elements shown in the embodiments.

### REFERENCE SIGN LIST

101: sample container, 102: sample transport unit, 103: reagent container, 104: reagent disk, 105: sample dispensing unit, 105a: sample dispensing probe, 106: reagent dispensing unit, 106a: reagent dispensing probe, 107: reaction disk, 108: measurement unit, 109: sample rack, 110: cleaning tank, 111: reaction container, 112: stirring unit, 113: control unit, 200: reservoir, 201: discharge tube, 202: flow path, 203: first valve, 204: syringe, 205: second valve, 206: tank, 301: cleaning liquid, 302: system water, 400: air layer

1. An automatic analyzer for analyzing a sample, the automatic analyzer comprising:
a dispensing probe configured to dispense the sample or a reagent;
a reservoir configured to reserve a cleaning liquid used for cleaning the dispensing probe;
a flow path connected to the reservoir and through which the cleaning liquid flows; and
a control unit configured to control each unit; wherein
the control unit draws the cleaning liquid in the reservoir into the flow path, and then supplies system water to the reservoir.

2. The automatic analyzer according to claim 1, wherein
the control unit draws the cleaning liquid into the flow path so that a liquid level of the cleaning liquid is located below an upper end of the flow path.

3. The automatic analyzer according to claim 1, wherein
the control unit forms an air layer between the cleaning liquid and the system water.

4. The automatic analyzer according to claim 1, wherein
the control unit suctions, before drawing the cleaning liquid into the flow path, at least a part of the cleaning liquid in the reservoir by the dispensing probe and discharges the cleaning liquid to an outside of the reservoir.

5. The automatic analyzer according to claim 1, wherein
the control unit supplies, before drawing the cleaning liquid into the flow path, the cleaning liquid to the reservoir and overflows the cleaning liquid from the reservoir.

6. The automatic analyzer according to claim 1, wherein
when the system water supplied to the reservoir is replaced with the cleaning liquid, the control unit suctions at least a part of the system water by the dispensing probe and discharges the cleaning liquid to an outside of the reservoir.

7. The automatic analyzer according to claim 1, wherein
when waiting time until cleaning of the dispensing probe is longer than a predetermined threshold value, the control unit draws the cleaning liquid into the flow path and supplies the system water to the reservoir.

8. The automatic analyzer according to claim 7, wherein
the threshold value is set according to a type of the cleaning liquid.

9. A method for controlling an automatic analyzer for analyzing a sample, the method comprising:
drawing a cleaning liquid reserved in a reservoir, the cleaning liquid being used for cleaning a dispensing probe for dispensing the sample or a reagent, into a flow path connected to the reservoir and through which the cleaning liquid flows; and
supplying system water to the reservoir.
